(19) United States
(12) Patent Application Publication
(10) Pub. No.: US 2005/0078413 A1
(43) Pub. Date: Apr. 14, 2005

(54) Head gimbal assembly with magnetic head slider and magnetic disk drive apparatus with head gimbal assembly

(75) Inventors: Tatsushi Shimizu, Kwai Chung (HK); Pak Kin Wong, Kwai Chung (HK); Hiroki Matsukuma, Tokyo (JP); Masaru Hirose, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: SAE Magnetics (H.K) Ltd., Kwai Chung (HK); TDK CORPORATION, Tokyo (JP)

(21) Appl. No.: 10/932,040

(22) Filed: Sep. 2, 2004

(30) Foreign Application Priority Data
Oct. 8, 2003 (JP) 2003/349066

(51) Int. Cl. G11B 5/60; G11B 5/012

(52) U.S. Cl. 360/234.5

(57) ABSTRACT

An HGA includes a magnetic head slider provided with at least one thin-film magnetic head element, and a conductive suspension to which the magnetic head slider is fixed. A conductive resistance between the magnetic head slider and the suspension is equal to or higher than 1 MΩ.

### PRIORITY CLAIM

This application claims priority from Japanese patent application No. 2003-349066, filed on Oct. 8, 2003, which is incorporated herein by reference.

### BACKGROUND OF THE INVENTION

1. Field of the Invention

The present invention relates to a head gimbal assembly (HGA) with a magnetic head slider mounted thereon and to a magnetic disk drive apparatus with the HGA.

2. Description of the Related Art

In a contact start/stop (CSS) magnetic disk drive apparatus, a magnetic head slider may become charged due to the friction between the slider and a magnetic disk when the disk starts its rotation, so that a potential difference may be produced between the slider and the disk.

Whereas, in a load/unload magnetic disk drive apparatus, a magnetic head slider does not in theory come into contact with a magnetic disk. However, in fact, they are frequently in contact with each other and thus a potential difference is also produced between the slider and the disk as well as in the CSS magnetic disk drive apparatus.

In general, a conductive adhesive or other conductive resin layer is inserted between a magnetic head slider and a metal flexure of a suspension for supporting the slider. Thus, if a voltage higher than a certain voltage is applied or induced across the slider and the flexure, electrical conduction will be produced due to electrostatic destructions occurred among conductive fillers mixed in the adhesive or the resin to dissipate static charges accumulated in the slider.

If no electrical conduction is provided between the slider and the flexure, the accumulated static charge in the slider cannot dissipate as a matter of course. In this case, when the slider with the accumulated static charge comes into contact with a magnetic disk, electrostatic discharge may occur between the slider and the disk causing a magnetic head element such as a giant magnetoresistive (GMR) effect head element to destruct.

It has been deemed to be that, as disclosed in Japanese patent publication No. 2002-343048A, if an electrical resistance between the magnetic head slider and the flexure is low, static charges accumulated in the slider can be easily dissipated to prevent electrostatic discharge between the slider and the magnetic disk.

In conventional magnetic disk drive apparatuses in operation, the probability of occurrence of lowered output of thin-film magnetic heads was about 1%. In other words, about 1% of the conventional magnetic disk drive apparatuses in operation had the problem of lowered magnetic head output. It has been considered that such lowered magnetic head output might be caused by mechanical damages of the GMR effect head element due to the contact of the magnetic head region of the magnetic head slider with the magnetic disk surface. In fact, clear contact flaws were observed on air bearing surfaces (ABSs) of the head regions in the most of such defective magnetic head sliders. Particularly, on the overcoat layer at the trailing edge, which would firstly come into contact with the magnetic disk, the flaws and scratches due to the contact between the slider and the disk were observed. Therefore, a remedy for preventing contact between the magnetic head region of the slider and the magnetic disk was carried out and a certain effect was produced.

However, even after such contact preventing measures were performed, about 1% of a certain model of magnetic disk drive apparatuses in operation exhibited the phenomenon of lowered magnetic head output. No contact flaws was observed on the ABS of the overcoat layer at the trailing edge, which would firstly come into contact with the magnetic disk, region in such defective magnetic head sliders. However, some damages were observed around the lower shield layer and the upper shield layer of the slider. Thus, it has been considered that there might be an unknown cause other than the cause due to the contact of the slider with the disk.

### BRIEF SUMMARY OF THE INVENTION

It is therefore an object of the present invention to provide an HGA with a magnetic head slider and a magnetic disk drive apparatus, whereby lowering of output of a magnetic head element in operation can be prevented from occurring.

According to the present invention, an HGA includes a magnetic head slider provided with at least one thin-film magnetic head element, and a conductive suspension to which the magnetic head slider is fixed. Particularly, according to the present invention, a conductive resistance or electrical resistance between the magnetic head slider and the suspension is equal to or higher than 1 MΩ.

According to the present invention, also, a magnetic disk drive apparatus includes at least one magnetic disk, and the abovementioned at least one HGA.

The present invention makes unknown cause of the phenomenon of lowered magnetic head output other than the cause due to the contact of the magnetic head slider with the magnetic disk clear, and proposes remedial measures thereof. As mentioned before, in the conventional magnetic disk drive apparatus, the conduction resistance between the magnetic head slider and the flexure was minimized so as to bring them into conduction when a voltage higher than a predetermined value is induced between the slider and the flexure to prevent electrostatic destruction (ESD). Also, it was designed that static charges accumulated in the slider is dissipated to prevent electrostatic discharge between the slider and the magnetic disk. However, these countermeasures were not enough.

The inventors of this application consider that the phenomenon of charging of the magnetic head slider and of inducing voltage between the slider and the magnetic disk are equivalent to the phenomenon occurred in a model with a capacitor placed instead of the slider and the magnetic disk. This capacitor has a withstand voltage, and when the applied voltage exceeds the withstand voltage, discharge of the accumulated static electricity occurs. Namely, it is considered that the cause of the phenomenon of lowered magnetic head output other than the cause of the contact of the magnetic head slider with the magnetic disk is the ESD of the magnetic head element due to the electrostatic discharge between the slider and the disk. Thus, a relationship of the conduction resistance between the magnetic head slider and the suspension with respect to the withstand voltage between the magnetic head slider and the magnetic disk is experimentally measured to provide remedial measures against discharge phenomenon. According to the experiments, it is revealed that the higher in the conduction resistance between the magnetic head slider and the suspension, the higher in the withstand voltage between the magnetic head slider and the magnetic disk resulting the discharge phenomenon to occur hard. Concretely, it is revealed that if the conduction resistance between the magnetic head slider and the suspension is equal to or higher than 1 MΩ, no discharge phenomenon occurs.

That is, according to the present invention, no discharge phenomenon occurs when the conduction resistance between the magnetic head slider and the suspension is equal to or higher than 1 MΩ, lowering of output of the magnetic head element in operation can be prevented from occurring.

It is preferred that the conductive resistance between the magnetic head slider and the suspension is equal to or lower than 500 MΩ. Thus, ESD can be prevented from occurring. If the conduction resistance exceeds than 500 MΩ, the slider is completely insulated from the suspension and therefore static charges accumulated in the slider cannot be escaped from the slider to the suspension. If there is no escaping route of the accumulated static charge, electrostatic discharge may occur between the magnetic head slider and the magnetic disk.

It is preferred that a conductive paste, a conductive adhesive and/or an insulation adhesive is inserted between the magnetic head slider and the suspension.

It is also preferred that the suspension includes a resilient metal flexure and a metal load beam supporting the flexure, and that the magnetic head slider is fixed on the flexure.

It is further preferred that the at least one thin-film magnetic head element includes a magnetoresistive (MR) effect head element utilizing GMR effect or tunnel magnetoresistive (TMR) effect.

Further objects and advantages of the present invention will be apparent from the following description of the preferred embodiments of the invention as illustrated in the accompanying drawings.

### BRIEF DESCRIPTION OF THE SEVERAL VIEWS OF THE DRAWINGS

FIG. 1 is an oblique view schematically illustrating main components of a magnetic disk drive apparatus in a preferred embodiment according to the present invention;

FIG. 2 is a plane view schematically illustrating the whole structure of an HGA in the embodiment of FIG. 1;

FIG. 3 is a side sectional view illustrating a top end section of the HGA in the embodiment of FIG. 1;

FIG. 4 is a graph illustrating a conduction resistance distribution of a conventional conductive resin;

FIG. 5 is a graph illustrating a conduction resistance distribution of a conductive resin such as a conductive adhesive or a conductive paste used in the embodiment of FIG. 1;

FIG. 6 is a block diagram illustrating a model for obtaining a relationship of a conduction resistance between a magnetic head slider and a suspension with respect to discharge;

FIG. 7 is an equivalent circuit diagram of the model of FIG. 6;

FIG. 8 is a simplified circuit diagram of the equivalent circuit of FIG. 7; and

FIG. 9 is a block diagram illustrating an actual HGA in operation, for obtaining a relationship of a conduction resistance between a magnetic head slider and a suspension with respect to discharge.

### DETAILED DESCRIPTION OF THE INVENTION

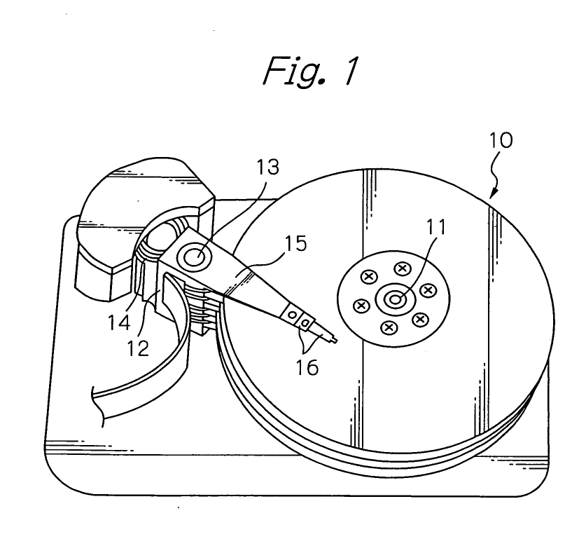

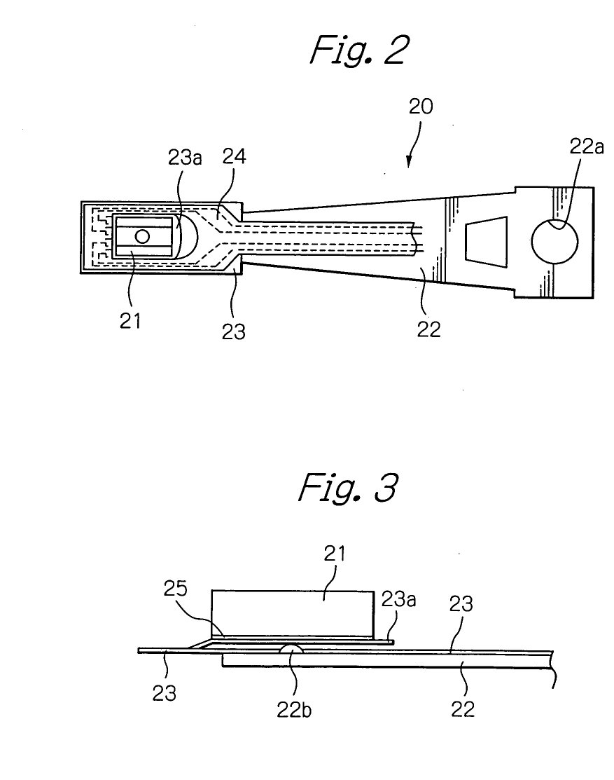

FIG. 1 schematically illustrates main components of a magnetic disk drive apparatus in a preferred embodiment according to the present invention, FIG. 2 schematically illustrates the whole structure of an HGA in this embodiment, and FIG. 3 illustrates a top end section of the HGA in this embodiment.

In FIG. 1, reference numeral 10 denotes a plurality of magnetic hard disks rotating around an axis 11, 12 denotes a carriage capable of rotating around an axis 13 for positioning a flying type magnetic head slider on a track, and 14 denotes a actuator such as for example a voice coil motor (VCM) for driving the carriage 12 to rotate.

Base sections at one ends of a plurality of drive arms 15 stacked along the axis 13 are attached to the carriage 12, and one or two HGAs 16 are mounted on a top section at the other end of each arm 15. Each of the HGAs 16 has the magnetic head slider mounted at its top end section so that the slider opposes to one surface of each of the magnetic disks 10.

As shown in FIG. 2, each HGA is assembled by fixing a magnetic head slider 21 with a thin-film magnetic head element such as a GMR effect head element or TMR effect head element to a top end section of a suspension 20.

The suspension 20 is substantially formed by a load beam 22, and a resilient flexure 23 fixed to the load beam 22. An attachment part 22a formed at a base end section of the load beam 22 is fixed to the drive arm 15 shown in FIG. 1.

The load beam 22 is made of in this embodiment a stainless steel plate, and supports the flexure 23 at its top end section. The fixing of the flexure 23 with the load beam 22 is performed by pinpoint welding at a plurality of points.

The flexure 23 has a flexible tongue 23a depressed by a dimple 22b (FIG. 3) formed on the load beam 22 at its one end section. On the tongue 23a, fixed is the magnetic head slider 21. The flexure 23 has elasticity for supporting flexibly the magnetic head slider 21 by this tongue 23a. The flexure 23 is made of in this embodiment a stainless steel plate.

On the load beam 22 and the flexure 23, a flexible conductor member 24 including a plurality of trace conductors of a thin-film multi-layered pattern is formed or disposed.

As shown in FIG. 3, the magnetic head slider 21 is fixed on the tongue 23a of the flexure 23 by an adhesive. Between the slider 21 and the tongue 23a of the flexure 23, a conductive paste 25 other than the adhesive is inserted. As for the adhesive, if an insulation adhesive is used, a high adhesion strength can be expected. However, in case that a somewhat lower adhesion strength is allowed, a conductive adhesive can be used as for the adhesive.

By inserting the conductive paste 25 with a proper conduction resistance other than the insulation adhesive as this embodiment or by using the conductive adhesive with a proper conduction resistance, a conduction resistance or electrical resistance between the magnetic head slider 21 and the flexure 23 is adjusted to a value equal to or higher than 1 MΩ and equal to or lower than 500 MΩ. As a result, no discharge occurs between the magnetic head slider and the magnetic disk, and thus lowering of output of the magnetic head element in operation can be prevented from occurring.

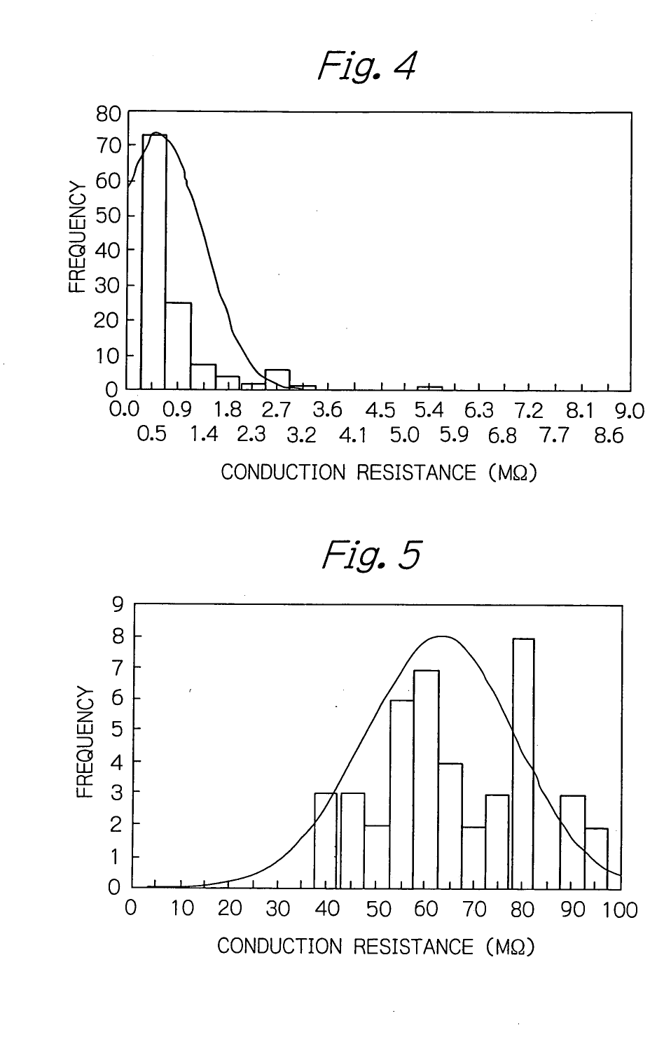

FIG. 4 illustrates a conduction resistance distribution of a conventional conductive resin, and FIG. 5 illustrates a conduction resistance distribution of a conductive resin such as the conductive adhesive or the conductive paste used in this embodiment.

As shown in FIG. 4, because an average conduction resistance of the conventional conductive resin is 0.5 MΩ, discharge occurs between the magnetic head slider and the magnetic disk causing the destruction of the magnetic head element. Contrary to this, as shown in FIG. 5, an average conduction resistance of the conductive resin used in this embodiment is 62 MΩ. By using the conductive paste with such conductive resin or by using the conductive adhesive with such conductive resin for assembling the HGA in the magnetic disk drive apparatus, as mentioned later, 0% of the magnetic disk drive apparatuses in operation exhibited the phenomenon of lowered magnetic head output.

In order to adjust the conduction resistance between the magnetic head slider and the flexure to a value equal to or higher than 1 MΩ and equal to or lower than 500 MΩ, the resistance of the conductive paste or the conductive adhesive inserted there between may be adjusted. Instead of this resistance adjustment of the conductive paste or the conductive adhesive, any method for controlling the conduction resistance between the magnetic head slider and the flexure can be used.

Hereinafter, reasons why the lower limit and the upper limit of the conduction resistance are thus defined will be described.

The most important point of the present invention is to define the lower limit of the conduction resistance. However, in order to prevent occurrence of electrostatic discharge, it is necessary to define the upper limit of the conduction resistance.

Experiments for obtaining the upper limit of the conduction resistance between the magnetic head slider and the suspension were performed under an environment temperature of 19-23° C., preferably 21° C., and an environment humidity of 50-60%, preferably 55%. As a result of the experiments, it was revealed that if the conduction resistance between the magnetic head slider and the suspension exceeds than 500 MΩ, the slider is completely insulated from the suspension and therefore static charges accumulated in the slider cannot be escaped from the slider to the suspension. If there is no escaping route of the accumulated static charge, electrostatic discharge occurs between the magnetic head slider and the magnetic disk. Thus, the upper limit of the conduction resistance should be 500 MΩ.

The lower limit of the conduction resistance was obtained from the following measurement.

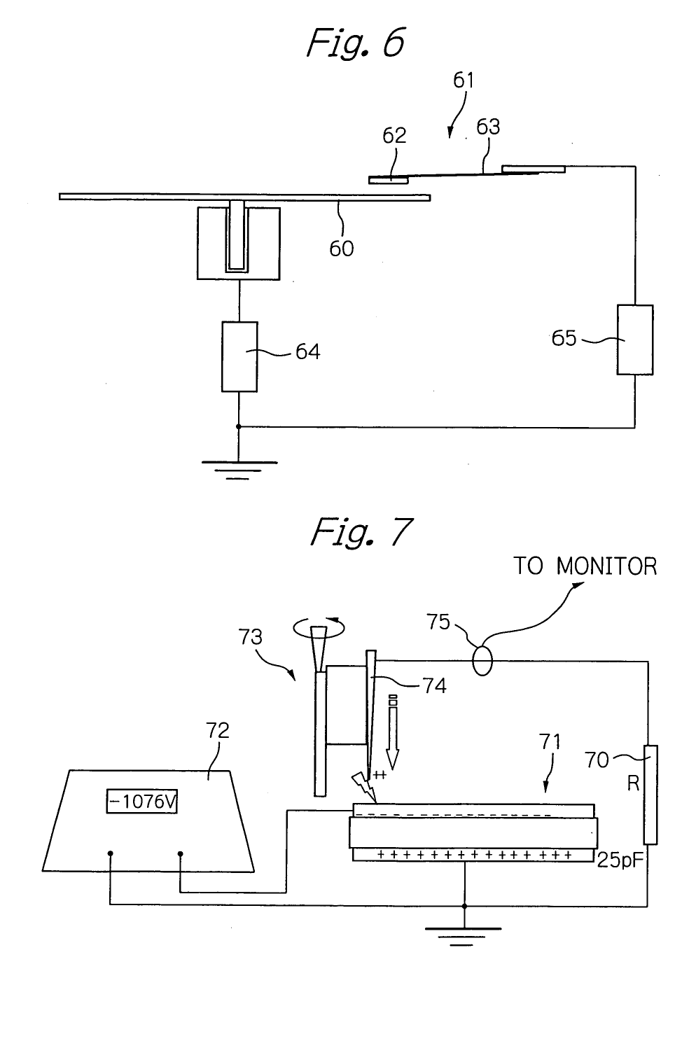

FIG. 6 illustrates a model for obtaining a relationship of a conduction resistance between the magnetic head slider and the suspension with respect to discharge, and FIG. 7 illustrates an equivalent circuit of this model.

In FIG. 6, reference numeral 60 denotes a magnetic disk, 61 denotes an HGA with a magnetic head slider 62 opposed to the disk 60 and a suspension 63 for supporting the slider 62, and 64 and 65 denote resistors with grounded one ends. The resistors 64 and 65 are equivalent to resistances other than a conduction resistance between the slider 62 and the suspension 63. In this model, the magnetic head slider 62 has a composite type thin-film magnetic head element with a GMR effect read head element and an inductive write head element, and the protection layer of the slider 62 is made of a diamond like carbon (DLC) film.

Actual measurement was performed by using the circuit shown in FIG. 7. In the figure, a resistor 70 corresponds to the conduction resistance between the slider 62 and the suspension 63, and a capacitor 71 simulates a relationship between the slider 62 and the magnetic disk 60. The capacitor 71 has the capacitance of 25 pF, and charged by an electrometer 72 to an optional voltage such as 1076 V for example. A lead needle 74 is gradually moved down until it touches the electrode plate of the capacitor 71 by rotating a translator 73, and thus a current flowing through the circuit is picked up by a current transformer 75 and measured by a monitor. In this measurement, the conduction resistance between the slider 62 and the suspension 63, represented by the resistor 70 is changed as parameters, for example, 0Ω, 10.3Ω, 1 kΩ, 50.9 kΩ and 1 MΩ. This measurement is repeated for ten times. The measured result is shown in Table 1.

TABLE 1

| | CONDUCTION RESISTANCE | | | | |
|---|---|---|---|---|---|
| | 0 Ω | 10.3 Ω | 1 kΩ | 50.9 kΩ | 1 MΩ |
| IS DISCHARGE | YES | YES | YES | YES | NO |
| PHENOMENON | | | | | |
| OCCURRED | | | | | |

As will be noted from Table 1, when the conduction resistance between the magnetic head slider and the suspension is equal to or higher than 1 MΩ, no discharge phenomenon occurs. The reason of this, namely why no discharge occurs when the conduction resistance increases, will be theoretically explained hereinafter.

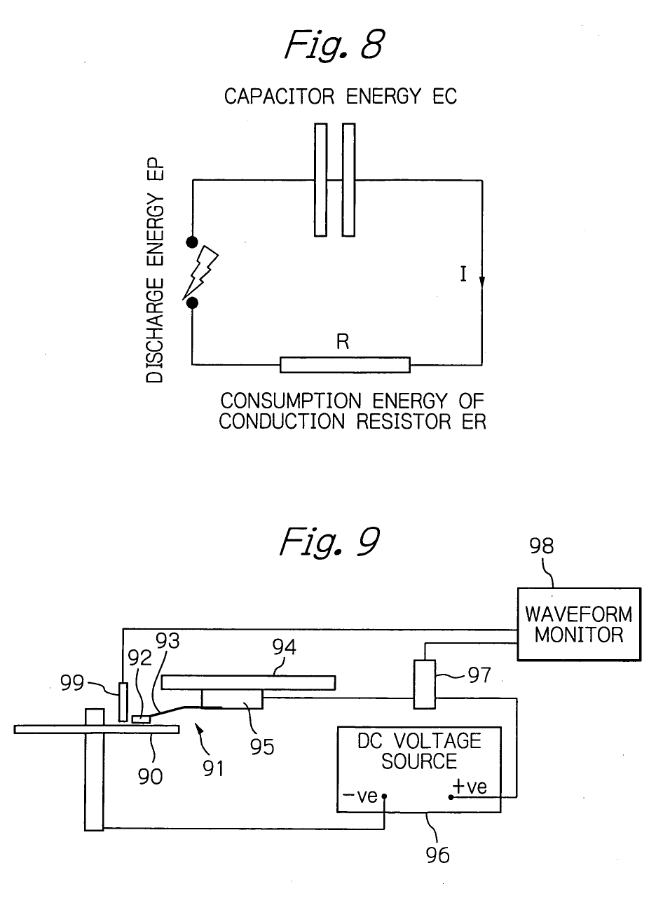

FIG. 8 illustrates a simplified circuit diagram of the equivalent circuit of FIG. 7.

If a capacitor energy between the magnetic head slider and the magnetic disk is represented by EC, a discharge energy between the magnetic head slider and the magnetic disk is represented by EP, an energy consumed at a conduction resistor between the magnetic head slider and the flexure or suspension is represented by ER, a flowing current is represented by I and a conduction resistance is represented by R, the following equations are given.
EC=EP+ER, ER=I²R
The energy EC accumulated between the magnetic head slider and the magnetic disk is consumed by the discharge (EP) and heating of the conduction resistor (ER). Thus, if the conduction resistance between the magnetic head slider and the flexure or suspension is low, the discharge energy EP becomes large. Contrary to this, if the conduction resistance is high, the discharge energy EP becomes small. Namely, in order to prevent occurrence of discharge, the conduction resistance between the magnetic head slider and the flexure or suspension should be determined high.

The lower limit of the conduction resistance between the magnetic head slider and the suspension was obtained from the following operation of the actual HGA.

FIG. 9 illustrates an actual HGA in operation, for obtaining a relationship of a conduction resistance between a magnetic head slider and a suspension with respect to discharge. Although the relationship between the magnetic head slider and the magnetic disk is simulated by the capacitor in the circuit of FIG. 7, the actual HGA is used for measurement in this circuit of FIG. 9.

In the figure, reference numeral 90 denotes a magnetic disk, and 91 denotes an HGA with a magnetic head slider 92 opposed to the disk 90 and a conductive suspension 93 for supporting the slider 92. The HGA 91 is fixed to a conductive support arm 95 that is supported by an insulation body 94, and electrically connected to one output terminal of a DC voltage source 96. The other output terminal of the DC voltage source 96 is electrically connected to the magnetic disk 90.

The conduction resistance between the magnetic head slider 92 and the suspension 93 was determined as parameters, for example, 200Ω, 350 kΩ, 1 MΩ, 5 MΩ, 10 MΩ and 46.2 MΩ, by adjusting the conductive resin of the conductive paste or the conductive adhesive inserted there between. Then, while 600 times of write operations at a frequency of 350 Hz were performed by the magnetic head element, whether or not to occur discharge was observed. No external voltage is applied thereto. The presence or absence of discharge was observed by a waveform monitor 98. Namely, a current flowing through the circuit is picked up by a current transformer 97 and measured by the monitor 98, and also the discharge phenomenon was caught by an antenna 99 mounted near the magnetic disk and the magnetic head slider 92 and observed by the monitor 98.

In this case, the magnetic head slider 92 has a composite type thin-film magnetic head element with a GMR effect read head element and an inductive write head element, and the protection layer of the slider 92 is made of a DLC film. The measured result is shown in Table 2.

TABLE 2

| | CONDUCTION RESISTANCE | | | | | |
|---|---|---|---|---|---|---|
| | 200 | 350 | | | | |
| | Ω | Ω | 1 MΩ | 5 MΩ | 10 MΩ | 46.2 MΩ |
| IS DISCHARGE | YES | YES | NO | NO | NO | NO |
| PHENOMENON | | | | | | |
| OCCURRED | | | | | | |

As shown in Table 2, no discharge phenomenon occurs when the conduction resistance between the magnetic head slider and the suspension is equal to or higher than 1 MΩ.

Furthermore, a relationship between the conduction resistance between the magnetic head slider and the suspension and the withstand voltage or discharge start voltage between the magnetic head slider and the magnetic disk was measured using the actual HGA shown in FIG. 9. The measured result is shown in Table 3.

TABLE 3

CONDUCTION RESISTANCE

| | 2 kΩ | 67 kΩ | 642 kΩ | 2.2 MΩ |
|---|---|---|---|---|
| WITHSTAND | 1.5 V | 2.0 V | 2.5 V | 3.5 V |
| VOLTAGE | | | | |
| (DISCHARGE | | | | |
| START | | | | |
| VOLTAGE) | | | | |

As shown in Table 3, when the conduction resistance between the magnetic head slider and the suspension is high, the withstand voltage or discharge start voltage between the magnetic head slider and the magnetic disk becomes large. It should be noted that this withstand voltage does not only depend upon kind of the resin inserted between the magnetic head slider and the suspension.

It is apparent that a structure of the suspension in the HGA according to the present invention is not limited to the aforementioned structure.

Many widely different embodiments of the present invention may be constructed without departing from the spirit and scope of the present invention. It should be understood that the present invention is not limited to the specific embodiments described in the specification, except as defined in the appended claims.

1. A head gimbal assembly comprising:
a magnetic head slider provided with at least one thin-film magnetic head element; and
a conductive suspension to which said magnetic head slider is fixed,
a conductive resistance between said magnetic head slider and said suspension is equal to or higher than 1 MΩ.

2. The head gimbal assembly as claimed in claim 1, wherein said conductive resistance between said magnetic head slider and said suspension is equal to or lower than 500 MΩ.

3. The head gimbal assembly as claimed in claim 1, wherein a conductive paste is inserted between said magnetic head slider and said suspension.

4. The head gimbal assembly as claimed in claim 1, wherein a conductive adhesive is inserted between said magnetic head slider and said suspension.

5. The head gimbal assembly as claimed in claim 4, wherein an insulation adhesive is also inserted between said magnetic head slider and said suspension.

6. The head gimbal assembly as claimed in claim 1, wherein said suspension includes a resilient metal flexure and a metal load beam supporting said flexure, and wherein said magnetic head slider is fixed on said flexure.

7. The head gimbal assembly as claimed in claim 1, wherein said at least one thin-film magnetic head element includes a magnetoresistive effect head element utilizing giant magnetoresistive effect or tunnel magnetoresistive effect.

8. A magnetic disk drive apparatus including at least one magnetic disk, and at least one head gimbal assembly,
said at least one head gimbal assembly comprising:
a magnetic head slider provided with at least one thin-film magnetic head element; and
a conductive suspension to which said magnetic head slider is fixed,
a conductive resistance between said magnetic head slider and said suspension is equal to or higher than 1 MΩ.

9. The magnetic disk drive apparatus as claimed in claim 8, wherein said conductive resistance between said magnetic head slider and said suspension is equal to or lower than 500 MΩ.

10. The magnetic disk drive apparatus as claimed in claim 8, wherein a conductive paste is inserted between said magnetic head slider and said suspension.

11. The magnetic disk drive apparatus as claimed in claim 8, wherein a conductive adhesive is inserted between said magnetic head slider and said suspension.

12. The magnetic disk drive apparatus as claimed in claim 11, wherein an insulation adhesive is also inserted between said magnetic head slider and said suspension.

13. The magnetic disk drive apparatus as claimed in claim 8, wherein said suspension includes a resilient metal flexure and a metal load beam supporting said flexure, and wherein said magnetic head slider is fixed on said flexure.

14. The magnetic disk drive apparatus as claimed in claim 8, wherein said at least one thin-film magnetic head element includes a magnetoresistive effect head element utilizing giant magnetoresistive effect or tunnel magnetoresistive effect.
